(19) United States
(12) Patent Application Publication
(10) Pub. No.: US 2006/0101641 A1
(43) Pub. Date: May 18, 2006

(54) Armature pin and method for assembly

(75) Inventors: Ryan M. True, Clawson, MI (US); Thomas A. Horn, Eastpointe, MI (US)

Correspondence Address: Patent Docket Administrator;BorgWarner Inc., 3850 Hamlin Road, Auburn Hills, MI, 48326, US

(73) Assignee: BorgWarner Inc., Auburn Hills, MI (US)

(21) Appl. No.: 11/217,246

(22) Filed: Sep. 1, 2005

Related U.S. Application Data
(60) Provisional application No. 60/627,883, filed on Nov. 15, 2004.

(51) Int. Cl. H01R 43/00; H01H 9/00; B22D 11/126

(52) U.S. Cl. 29/854; 29/875; 29/527.5; 29/729; 335/203; 335/55

(57) ABSTRACT

Armature pin assemblies and methods for forming the same are described. A first portion of a pin member is placed in a die cavity so as to expose a second portion of the pin member. An amount of metal powder is placed into the die cavity so as envelope the second portion of the pin member. A press member is then brought into contact with the metal powder so as to compress the same and form an armature member. The pin member is fastened to the armature member by the press operation so as to form a unitary armature pin assembly.

### CROSS-REFERENCE TO RELATED APPLICATION

The instant application claims priority to U.S. Provisional Patent Application Ser. No. 60/627,883, filed Nov. 15, 2004, the entire specification of which is expressly incorporated herein by reference.

### FIELD OF THE INVENTION

The present invention relates generally to armatures and more particularly to armature pin assemblies wherein pins are insert molded in metal powder when the armatures are formed, and methods for forming the same.

### BACKGROUND OF THE INVENTION

Electric solenoids have been used to provide a number of functions in automotive applications including, but not limited to idle speed control, exhaust gas recirculation valves, fuel vapor purge valves, and the like. The basic construction of a traditional solenoid typically includes an armature member having a pin member (e.g., a stem) member extending therefrom. The other main components of a traditional solenoid include a pole piece, coil, flux tube, and an area defining an air gap. The air gap is generally defined as a variable space between the facing surfaces of the armature and the pole piece.

Conventionally, the armature member and the pin member were typically separately constructed, and then joined together by installing (e.g., by pushing with a press) the pin member into an orifice (e.g., a bore) formed on a surface of the armature member. Unfortunately, this methodology was not especially cost and labor efficient, and occasionally lead to damage to either the armature member and/or the pin member (e.g., bent pins). Furthermore, performance issues, such as those including misalignment of the components, material contamination, varying high press force levels, and the like, were observed in conventionally constructed armature pin assemblies.

Accordingly, there exists a need for new and improved armature pin assemblies and methods for making the same.

### SUMMARY OF THE INVENTION

In accordance with the general teachings of the present invention, new and improved armature pin assemblies and methods for making the same are provided.

In accordance with a first embodiment of the present invention, a method for forming an armature pin assembly is provided, comprising: (1) providing a die having a cavity formed therein; (2) providing a pin member; (3) positioning the pin member within the cavity; (4) charging an amount of metallic material into the cavity so as to envelope at least a portion of the pin member; (5) compressing the metallic material so as to form an armature member about the pin member, wherein the pin member is fastened to the armature member.

In accordance with a second embodiment of the present invention, a system for forming an armature pin assembly is provided, comprising: (1) a die having a cavity formed therein, wherein the cavity is operable to receive a metallic material; (2) an area defining a bore formed on a surface of the die, wherein the bore is operable to at least partially receive a pin member such that the pin member is at least partially disposed within the cavity; and (3) a compression system, wherein the cavity is operable to receive a metallic material so as to at least partially envelope the pin member, wherein when the compression system is actuated it is operable to come into contact with the metallic material so as to form an armature member about the pin member, wherein the pin member is fastened to the armature member.

In accordance with a third embodiment of the present invention, an armature pin assembly is provided, comprising: (1) a pin member; and (2) an armature member, wherein the armature member is formed by the process of: (a) providing a die having a cavity formed therein; (b) positioning the pin member within the cavity; (c) charging an amount of metallic material into the cavity so as to envelope at least a portion of the pin member; (d) compressing the metallic material so as to form the armature member about the pin member, wherein the pin member is fastened to the armature member.

Further areas of applicability of the present invention will become apparent from the detailed description provided hereinafter. It should be understood that the detailed description and specific examples, while indicating the embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an armature pin assembly, in accordance with the general teachings of the present invention;

FIG. 2 is a perspective view of a die member for producing an armature pin assembly, in accordance with one embodiment of the present invention;

FIG. 3 is a broken-away perspective view of the die member depicted in FIG. 2 including an optional ejection system, wherein a pin member is shown disposed in the die member, in accordance with an alternative embodiment of the present invention;

FIG. 4 is a broken-away perspective view of the die member depicted in FIG. 3 wherein an amount of metallic material has been charged into the die cavity so as to envelope the exposed portion of the pin member, in accordance with an alternative embodiment of the present invention;

FIG. 5 is a broken-away perspective view of the die member depicted in FIG. 4 wherein a compression member is brought into contact with the metallic material, in accordance with an alternative embodiment of the present invention;

FIG. 6 is a broken-away perspective view of the die member depicted in FIG. 5 wherein the metallic material has been compressed, in accordance with an alternative embodiment of the present invention;

FIG. 7 is a broken-away perspective view of the die member depicted in FIG. 6 wherein the armature pin assembly is ejected from the die member by the ejection system, in accordance with an alternative embodiment of the present invention; and

FIG. 8 is a perspective view of the armature pin assembly fully ejected from the die member depicted in FIG. 7, in accordance with an alternative embodiment of the present invention.

### DETAILED DESCRIPTION OF THE INVENTION

The following description of the embodiment(s) of the present invention is merely exemplary in nature and is in no way intended to limit the invention, its application, or uses.

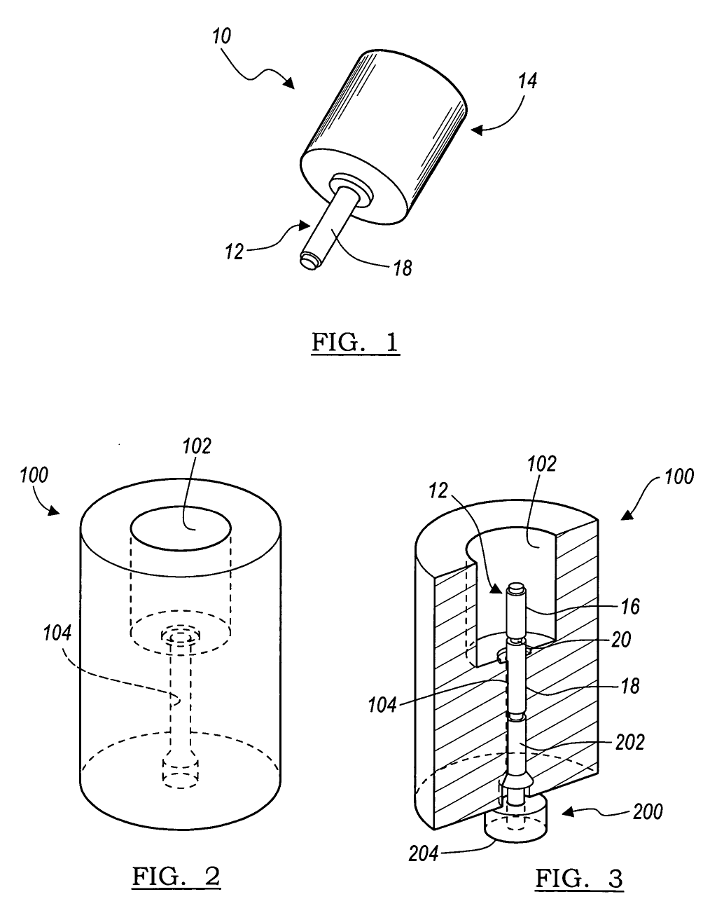

Referring to the Figures generally, and more specifically to FIG. 1, there is generally shown an armature pin assembly 10, in accordance with the general teachings of the present invention. The assembly 10 primarily includes a pin member 12 and an armature member 14 formed thereabout. That is, the pin member 12 is not pushed or placed in an aperture formed in the armature member 14 (as is the case in conventional armature pin assemblies), but rather the armature member 14 is caused to be shaped or otherwise formed about the pin member 12 such that the two components are fastened to one another so as to form a unitary assembly.

The exact dimensions of the pin member 12 are not thought to be critical to the success of the present invention, provided that it is able to accommodate the formation of the armature member 14 thereabout and furthermore resist separation from the armature member 14 once the assembly 10 is formed.

In accordance with an aspect of the present invention, the pin member 12 is provided with a first end portion 16 and a second end portion 18, wherein the terms “first” and “second” are used for reference purposes only. Without being bound to a particular theory of the operation of the present invention, one end portion of the pin member 12 is submerged within the body of the armature member 14, wherein the other end portion of the pin member 12 extends outwardly from the body of the armature member 14.

In accordance with another aspect of the present invention, the pin member 12 is provided with a notch 20 formed along a surface thereof so as to provide an area for the material of the armature member 14 to form a locking arrangement therewith. The notch 20 can be continuous (e.g., forming a recessed area extending along the entire circumference of the pin member 12) or can be discontinuous (e.g., forming at least one recessed area that does not extend along the entire circumference of the pin member 12).

In order to form the assembly 10 of the present invention, a die member 100 as generally shown in FIG. 2 is employed, in accordance with one embodiment of the present invention. The die member 100 includes an area defining a cavity 102 and an area defining a bore 104 (e.g., a throughbore) in communication with the cavity 102. Without being bound to a particular theory of the operation of the present invention, the general dimensions and configurations of the cavity 102 are suitable for forming the armature member 14 of the present invention.

Referring to FIG. 3, there is shown an optional ejection system 200 in operable association with the die member 100, in accordance with an alternative embodiment of the present invention. The ejection system 200 is in communication with the bore 104, e.g., at least a portion of the ejection system 200 is received within the bore 104.

In accordance with an aspect of the present invention, the ejection system 200 includes an ejection member 202 and an actuation system 204 that is selectively operable to cause the ejection member to deploy, i.e., to extend upwardly through the bore 104 towards the cavity 102.

Once the die member 100 and the optional ejection system 200 are properly positioned, the pin member 12 is placed in the upper portion 104a of the bore 104 such that it contacts and rests upon the ejection member 202, which is in proximity to the lower portion 104b of the bore 104. It should be appreciated that seals, bearings, or the like can be used to either seal off a portion of the cavity 102 from the bore 104, or alternatively, to support the pin member 12. Without being bound to a particular theory of the operation of the present invention, the tolerance between the opening 104c and the pin member 12 is substantially close, such that material in proximity thereto cannot easily enter into the bore 104.

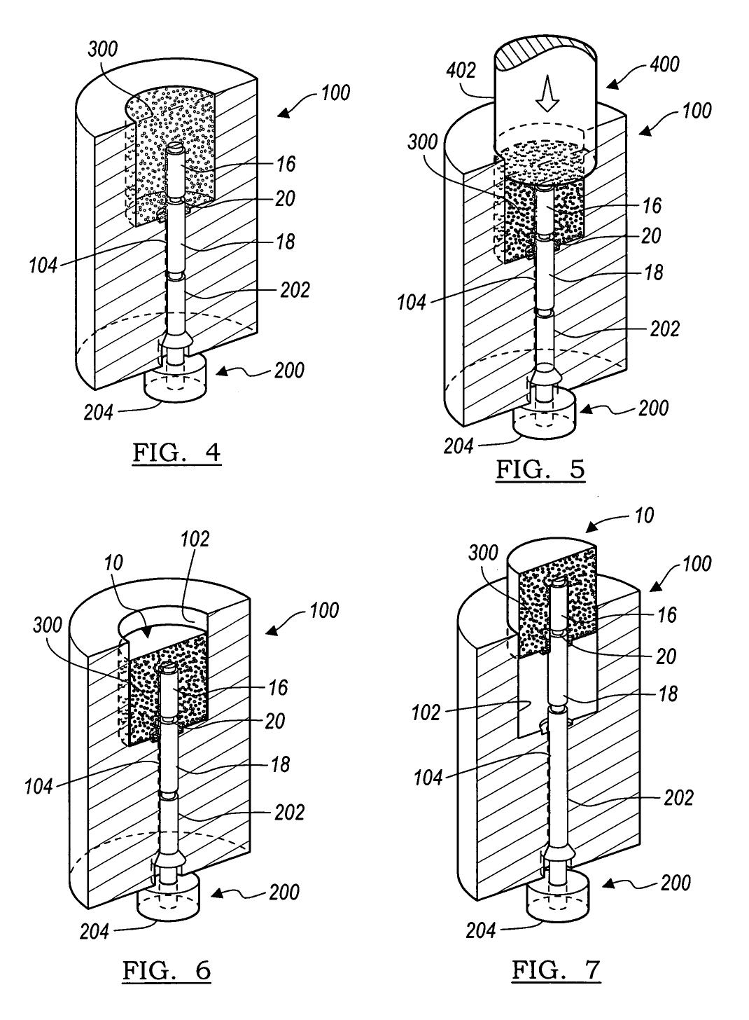

Referring to FIG. 4, once the pin member 12 has been properly positioned in the bore 104, an amount of metallic material 300, such as but not limited to metal powder, is charged or otherwise placed into the cavity 102 such that it at least substantially envelopes or otherwise surrounds the exposed portion of the pin member 12 (in this case, the first end 16 of the pin member 12). As previously noted, the pin member 12 can be configured in any number of shapes so long as it can form a locking arrangement with the metallic material 300, e.g., in proximity to the notch 20. Although the metallic material 300 is shown as completely filling the cavity 102, it should be appreciated that less than this amount can be used, depending on the particular requirements of the assembly process.

Referring to FIG. 5, once a sufficient amount of the metallic material 300 has been charged into the cavity 102, a compression system 400 is employed to compress the metallic material 300 to a pre-determined shape and/or configuration, e.g., an armature member 14. In accordance with an aspect of the present invention, the compression system 400 includes a compression member 402 (e.g., a punch, press or the like) that is selectively operable to contact the metallic material 300, e.g., in a downwardly manner, with sufficient force so as to compress, compact, or otherwise shape the metallic material 300 into a suitable shape and/or configuration, e.g., an armature member 14.

Referring to FIG. 6, once the metallic material 300 has been properly compressed, the assembly 10 is considered to be formed, i.e., the armature member 14 has been formed about the pin member 12 so as form a unitary member. As previously noted, the metallic material 300 infiltrates the area in proximity to the notch 20 of the pin member 12 so as to form a locking arrangement therewith, e.g., when the metallic material 300 is compressed. At this point, the assembly 10 is removed from the cavity 102 of the die member 100 by any number of suitable methods.

Referring to FIG. 7, the ejection system 200 is deployed to remove the finished assembly 10 from the cavity 102 of the die member 100. Without being bound to a particular theory of the operation of the present invention, the ejection member 202 is deployed (e.g., upwardly towards the cavity 102) by the actuation system 204 so as to cause the ejection member 202 to contact the pin member 12 with sufficient force so as cause the assembly 10 to dislodge from the cavity 102. In this manner, manipulation of the various portions of the assembly 10 is minimized, thus potentially preventing damage thereto during the extraction process form the cavity 102.

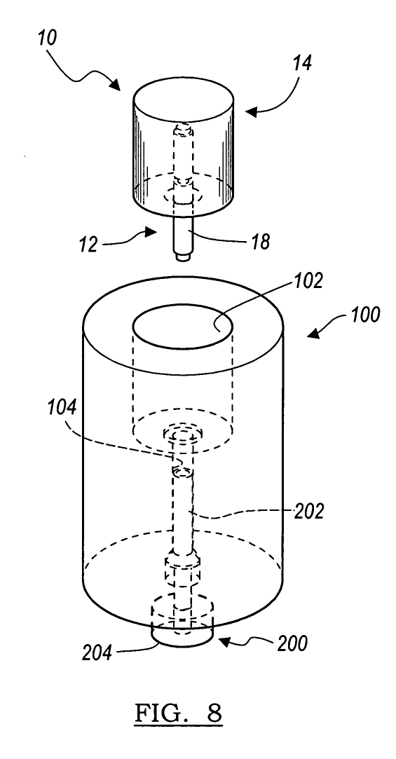

Referring to FIG. 8, the assembly 10 is shown completely ejected from the die member 100, and is ready for use and/or further processing. The die member 10 can then be used to form additional units of the assembly 10. With respect to further processing, as the assembly 10 may be in the green state after ejection, the assembly 10 can then be sintered. By way of a non-limiting example, in a typical sintering operation, the green compacted parts are placed on a conveyer or like device that travels through a furnace or like device at a controlled rate depending on the particular alloy being sintered. This sintering process typically completes the inter-particle bonding of the metallic material to become the final part when cooled.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for forming an armature pin assembly, comprising:
providing a die having a cavity formed therein;
providing a pin member;
positioning the pin member within the cavity;
charging an amount of metallic material into the cavity so as to envelope at least a portion of the pin member;
compressing the metallic material so as to form an armature member about the pin member;
wherein the pin member is fastened to the armature member.

2. The invention according to claim 1, further comprising the step of providing an ejection system.

3. The invention according to claim 2, wherein the ejection system is in communication with the bore.

4. The invention according to claim 2, wherein the ejection system is selectively operable to contact the pin member.

5. The invention according to claim 1, further comprising the step of ejecting the armature pin assembly from the cavity after formation of the armature member has been completed.

6. The invention according to claim 1, wherein the metallic material comprises powder metal.

7. The invention according to claim 1, wherein the compressing step comprises selectively contacting the metallic material with a punch member.

8. The invention according to claim 1, wherein a portion of the pin member and the metallic material are in a locking arrangement.

9. The invention according to claim 1, wherein the pin member includes an area defining a recessed portion, wherein the metallic material is operable to infiltrate into the recessed portion so as to form a locking arrangement therebetween.

10. A system for forming an armature pin assembly, comprising:
a die having a cavity formed therein, wherein the cavity is operable to receive a metallic material;
an area defining a bore formed on a surface of the die, wherein the bore is operable to at least partially receive a pin member such that the pin member is at least partially disposed within the cavity; and
a compression system;
wherein the cavity is operable to receive the metallic material so as to at least partially envelope the pin member;
wherein when the compression system is actuated it is operable to come into contact with the metallic material so as to form an armature member about the pin member;
wherein the pin member is fastened to the armature member.

11. The invention according to claim 10, further comprising an ejection system.

12. The invention according to claim 11, wherein the ejection system is in communication with the bore.

13. The invention according to claim 11, wherein the ejection system is selectively operable to contact the pin member.

14. The invention according to claim 10, wherein the armature pin assembly is ejected from the cavity after formation of the armature member has been completed.

15. The invention according to claim 10, wherein the metallic material comprises powder metal.

16. The invention according to claim 10, wherein the compression system comprises a punch member that is selectively operable to contact the metallic material.

17. The invention according to claim 10, wherein a portion of the pin member and the metallic material are in a locking arrangement.

18. The invention according to claim 10, wherein the pin member includes an area defining a recessed portion, wherein the metallic material is operable to infiltrate into the recessed portion so as to form a locking arrangement therebetween.

19. An armature pin assembly, comprising:
a pin member; and
an armature member;
wherein the armature member is formed by the process of:
providing a die having a cavity formed therein;
positioning the pin member within the cavity;
charging an amount of metallic material into the cavity so as to envelope at least a portion of the pin member;
compressing the metallic material so as to form the armature member about the pin member;
wherein the pin member is fastened to the armature member.

20. The invention according to claim 19, further comprising an ejection system operably associated with the die.

21. The invention according to claim 20, wherein the ejection system is in communication with an area defining a bore formed in a surface of the cavity.

22. The invention according to claim 20, wherein the ejection system is selectively operable to contact the pin member.

23. The invention according to claim 19, wherein the armature pin assembly is ejected from the cavity after formation of the armature member has been completed.

24. The invention according to claim 19, wherein the metallic material comprises powder metal.

25. The invention according to claim 19, wherein the compressing step comprises selectively contacting the metallic material with a punch member.

26. The invention according to claim 19, wherein the at least a portion of the pin member and the metallic material are in a locking arrangement.

27. The invention according to claim 19, wherein the pin member includes an area defining a recessed portion, wherein the metallic material is operable to infiltrate into the recessed portion so as to form a locking arrangement therebetween.
